(19) United States
(12) Patent Application Publication
(10) Pub. No.: US 2011/0256362 A1
(43) Pub. Date: Oct. 20, 2011

(54) MODIFIED FIBROUS PRODUCT AND METHOD OF PRODUCING THE SAME

(75) Inventors: Hannu Mikkonen, Vtt (FI); Tero Malm, Vtt (FI); Vesa Kunnari, Vtt (FI); Elias Retulainen, Vtt (FI)

(73) Assignee: TEKNOLOGIAN TUTKIMUSKESKUS VTT, Espoo (FI)

(21) Appl. No.: 13/125,026

(22) PCT Filed: Oct. 20, 2009
(86) PCT No.: PCT/FI2009/050843

§ 371 Date: Jul. 11, 2011

(30) Foreign Application Priority Data
Oct. 20, 2008 (FI) 20085990

(51) Int. Cl. B32B 3/00; B05D 5/06

(52) U.S. Cl. 428/195.1; 427/161

(57) ABSTRACT

The present invention relates to a modified fibrous product and a method of producing the same. According to the method, transparent areas are generated in the fibrous product, such as in a paper or a cardboard sheet or in a paper or a cardboard web. According to the present invention, a carbohydrate derivative that includes a plasticizer is incorporated into the fibrous product, and the carbohydrate derivative, which is plasticized with the plasticizer, is brought, in a liquid state and under pressure, to migrate in between the fibres of the product in such a way that at least part of the plasticizer penetrates into the lumens of the fibres, in which case the fibrous product becomes transparent in the treated area. By using the solution, it is possible to simplify the method of further processing paper or cardboard for consumer packages. The present invention can be applied to, among other products, envelopes having a window through which the address is visible. Other applications are all kinds of foodstuff and consumer packages in which windows for product display are currently used.

The present invention relates to a method of producing a modified fibrous product according to the preamble of claim 1.

According to such a method, transparent areas are generated in a fibrous product, such as in a paper or a cardboard sheet or a paper or a cardboard web or a paper or a cardboard product.

The present invention also relates to a product according to the preamble of claim 26.

Paper and cardboard packages are often equipped with windows, through which the product to be sold is visible. Traditionally, a window is made in such a way that a piece of the paper or the cardboard is cut off and replaced with a slightly larger piece of a plastic material which is glued, and which in most cases comprises polypropylene or polyethene.

Substantial disadvantages are associated with the prior art. The traditional production method includes several stages, the plastic materials used are not biodegradable, the plastic material must cover part of the fibrous product edge, too, in order to fix the said material and often a separate adhesive is needed for the fixing.

The purpose of the present invention is to eliminate at least part of the disadvantages associated with the known technology and to generate a completely new solution for generating transparent or translucent areas in the fibrous product.

The present invention is based on the idea that a carbohydrate derivative that includes a plasticizer is incorporated into the fibrous product. It is possible to bring the plasticizer into the fibrous product together with the carbohydrate derivative or separately. The carbohydrate derivative which is plasticized with a plasticizer is brought under pressure into a liquid state, to migrate in between the fibres of the product in such a way that at least part of the plasticizer penetrates into the lumens of the fibres.

With regard to the prior art, we can refer to a method of treating paper, described in GB Patent Specification No. 1 012 120, in which method watermark-like transparent areas are formed by impregnating the paper with different chemicals. However, carbohydrate derivatives, such as those used in the present invention, are not mentioned in the publication, sucrose acetate isobutyrate being used instead; neither is there any reference in the publication to the present method, in which a plasticized and liquid-state carbohydrate derivative is, under pressure, incorporated into the paper.

In JP Specification No. 2665566, the transparency of paper is improved by applying onto its surface paraffin, a higher fatty acid or a fatty acid alcohol ester or a similar material, which is diluted in a solvent, such as benzene, toluene or xylene, or in chlorinated hydrocarbon or in alcohol. Similarly, in this JP publication no reference is made to the present solution.

Thus, by means of the present invention, a fibrous product is generated which has at least one transparent area that comprises carbohydrate derivative, which in turn is plasticized with a plasticizer.

More specifically, the method according to the present invention is primarily characterized by what is stated in the characterizing part of claim 1

The product according to the invention is, in turn, characterized by what is stated in the characterizing part of claim 26.

Considerable advantages can be achieved with the present invention. Thus, by using the solution, it is possible to simplify the further processing of paper or cardboard for consumer packages. In addition, the use of biodegradable plastics in paper packages makes it easier to recycle those packages. Although different technologies exist for generating transparent or translucent paper, those methods do not make it possible to generate localised transparency; instead, the width of the product is the same as that of the roll of the paper mill (for instance in the production of parchment paper).

With the present invention it is possible to generate local transparencies, in which case the process of gluing the plastic films, which is currently used, can be eliminated.

Here, local addition of material means dosing the liquid polymer hot onto the surface of the paper, onto an area of a desired size, by means of an orifice or a roller, followed by a compressing stage. It is also possible to bring a meltable polymer as a film, i.e. pieces of film that are cut-to-shape, onto the surface of the paper or cardboard, and then hot press it into the fibrous network, as described in more detail below.

Because biodegradable polymers are used, it is possible to mould or compost the waste from the recycling process.

The present invention can be applied to, among other products, envelopes having a window through which the address is visible. Other applications are all foodstuff and consumer packages in which windows for product display are currently used. The present invention can also be used to generate transparent patterns in “watermarked” paper.

In the following, the present invention will be examined more closely with the aid of a detailed description and the attached FIGURES.

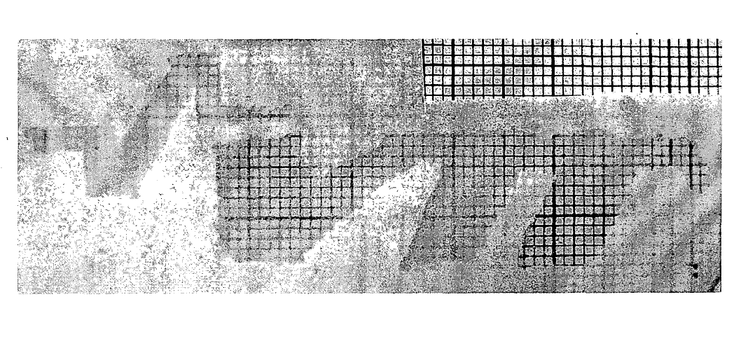

FIG. 1 shows a photograph of the product which is prepared according to example 10.

As described above, the method according to the present invention generates a modified fibrous product, the surface of which is at least partly prepared to be transparent. Generally, one or several limited transparent areas are generated in the surface.

Hereafter, the modified fibrous product or its sub-areas are called “transparent” when it is meant that a symbol which is situated under the product or the surface (on the other side in relation to the viewer), such as text or figure or colour or similar marking, is visible or readable or otherwise optically detectable through the modified area of the fibrous product. In general, the present invention aims at essentially changing or controlling, or both, the permeability of visible light and of UV and IR radiation. Thus, the term “transparent” refers to products which have been prepared to be either “transparent” or “translucent”.

It should also be noted that the permeability within different wavelength ranges can be changed by using different colour/additive agents. In certain products, the aim is to limit the penetration of the UV radiation, which otherwise might easily trigger reactions in, for instance, foodstuffs, but at the same time allow the penetration of visible light.

According to the initial embodiment of the present invention, a carbohydrate derivative in liquid state is applied, i.e. spread onto the surface of the fibrous product, and allowed to penetrate in between the fibres of the product. The application is enhanced with pressure and, if needed, with an elevated temperature.

According to another embodiment of the invention, an intermediate agent (filler), which is meltable is incorporated in the fibrous product, among the fibres. The agent is added to the paper product by using, for instance, a conventional technique for using fillers.

In both applications, a carbohydrate derivative which can be plasticized by using a softener, i.e. a plasticizer, is used. When the carbohydrate derivative is applied onto the fibrous product under pressure, or when a plasticizer is added to the fibrous product which comprises carbohydrate derivative and when, subsequently or at the same time as the application of the plasticizer, pressure and perhaps an elevated temperature is directed at the product, it is possible that at least part of the plasticizer is separated from the plasticized carbohydrate derivative and penetrates in between the fibres, especially into their lumens.

In principle, in the initial embodiment of the present invention, the meltable polymer can be applied locally onto the surface of the paper as an aqueous dispersion, which also comprises the melting additives needed. The dispersion can be applied onto a desired surface by using a printing technique, in which case the treatment, which is carried out under heat and pressure (compression) simultaneously with or subsequent to the application, generates locally a transparent area when the polymer melts and fills the intermediate space between the fibres.

According to another embodiment of the present invention, a meltable biopolymer filler, such as starch ester, is first added into the fibrous web, after which the paper is treated, within a precisely defined area, with an additive which plasticizes the polymer; this additive could be as simple as plain water or a plasticizer diluted in water, or a liquid plasticizer as such or one that is melted. It is possible to apply plasticizing agents onto the fibrous web by using a printing technique, followed by hot compression stage which makes the polymeric filler melt completely.

Preferably, the intermediate agent between the fibres is a material, the refractive index of which is as close as possible to the index of cellulose. The refractive index of air is 1 and of water approximately 1.33; that of the cell wall of a dry soya leaf is 1.51-1.545, which is a figure that is probably closest to that of wood fibre. Examples of the refractive indexes of hydrocarbon derivatives are: cellulose-caprate (hexane acid ester of cellulose)=1.47, cellulose acetate=1.475, starch acetate=1.47, regenerated cellulose film (dry)=1.535-1.55. Compare this with the index of glass, which varies between 1.5-1.8. If necessary, it is possible to carry out additional comparisons by means of microscope immersion oils.

In view of the above, is possible to impregnate the area to be treated with a carbohydrate derivative, in which case at least part of the carbohydrate plasticizer, which is a relatively small-molecular material—compared with the carbohydrate derivative—is separated from the matrix of the carbohydrate derivative and penetrates farther into the lumens of the fibres.

Typically, at least approximately 10 weight-%, preferably approximately 25 weight-% of the plasticizer is separated from the carbohydrate derivative during the application. Of this quantity, at least approximately 5 weight-%, most suitably approximately 10-90 weight-% is brought to penetrate into the fibre lumens of the fibrous product.

In particular, carbohydrate products which can be liquified at relatively low temperatures are used in the present invention.

According to one preferable embodiment, the carbohydrate derivative is heated before the application.

As described in more detail below, depending on which carbohydrate derivative is used, the application temperature is generally approximately 20-250° C., especially approximately 50-200° C., most suitably approximately 50-150° C. Here, “melting point” means the threshold temperature at which the carbohydrate derivative becomes liquid at non-pressure or especially at pressure conditions.

As explained above, “carbohydrate derivatives” mean chemical derivatives which are obtained by traditional derivations, and derivatives generated from these by further processing, which are obtained from carbohydrates, especially long-chained carbohydrates, such as starch, dextrin, cellulose and hemicelluloses and corresponding polymers.

It is also possible to use other carbohydrate derivative-like thermoplastic biopolymers, such as PLA (polylactic acid), as initial materials. We have discovered through experimentation that these materials can generate a desired transparency effect at least in relatively thin papers (grammage from 5 or 10 g to at least 110 g/m², the examples relate to paper having a grammage of 60 g/m²). If desired, the ductility of PLA can be improved by blending it with acetylated carbohydrate. Thus, according to a preferable embodiment of the present invention, PLA is blended with oxidized amylose starch acetate, in which case the ductility of the PLA starch polymer mixture increases by 150% without breaking, compared with plain PLA plastic.

A special advantage of the traditional carbohydrate derivatives is their low melt viscosity.

Thus, preferably one or two carbohydrate derivatives are used, for instance cellulose, starch or dextrin derivatives and mixtures of two or more derivatives. Examples of such derivatives are: cellulose C₁₋₄ alkyl ester, oxidized cellulose C₁₋₄ alkyl ester, starch C₁₋₄ alkyl ester, oxidized starch C₁₋₄ lower alkyl ester, and corresponding ethers and mixtures of esters and/or ethers. Suitable derivatives are particularly cellulose and starch esters and ethers, especially lower alkyl esters, such as methyl, ethyl, propyl and butyl esters (cellulose or starch formate, -acetate, -propionate and -butyrate).

Besides common derivatives, it is also possible to use products, the molar masses of which are lowered by, for instance, oxidizing or transglycosylation or by a combination of these.

In a transglycosylation reaction, diols are connected for instance to a cellulose or starch derivative and, at the same time, the molar mass of the carbohydrate derivative decreases. In the case of cellulose derivatives, this reaction has not been reported previously in literature.

It is possible to carry out the transglycosylation reaction of cellulose derivatives by means of a homogeneous batch reaction by using diol and cellulose ester in a mass proportion of 1:1-1:10, or by means of a reactive extrusion by using 5-10% of diol calculated from the mass of the initial material. It is possible to use corresponding conditions for other carbohydrate derivates, too.

According to one embodiment, these transglycosylation or oxidizing products of carbohydrates, particularly cellulose, are produced from cellulose derivatives, especially from esters or ethers, by using a continuously operating mechano-chemical extrusion process, in which the alcohol component, if desired, the catalyst or the oxidizing chemical, is used either totally or bound to the product by a chemical bond.

We have unexpectedly discovered that the reaction is successful when a total dose of 1-10% of alkanol and/or oxidizing chemical is used. For comparison and as a supplementary test, the transglycylation of the cellulose ester and the alkanol were carried out as a batch reaction in which the weight ratio between alkanol and cellulose polymer was 10:1.

By way of a complementary technique, it is possible to further reduce the molar mass of carbohydrate, particularly cellulose, in solid state by breaking the cellulose molecules by means of peroxide-oxidizing. The peroxide degradation provides an advantage in a situation where it is not appropriate to modify the chemical functionality of the cellulose polymer or of another carbohydrate derivative, but only to adjust the molar mass to the desired size.

According to one embodiment of the present invention, the compound is hydrogen peroxide, which, in the reaction stage, forms hydroperoxides; these peroxides decompose into gaseous products and are thus removed from the reaction mixture. In principle, it would be possible to generate the same reaction with numerous peroxo compounds, such as persulphate, peroxosulphuric acid and organic peroxides.

According to a preferable embodiment of the present invention, 0.1-10% of peroxide is used, calculated from the dry weight of the carbohydrate derivative, particularly the cellulose derivative.

The product, which is obtained as such from the carbohydrate derivative or after transglycosylation or oxidizing, is plasticized before application. The glass transition temperature of the plasticized carbohydrate derivative is most suitably at maximum 210° C., especially at maximum 170° C., most suitably at maximum 150° C.

In the present invention an “external plasticizer” which is preferably a monomeric plasticizer is most suitably used for the plasticizing of the carbohydrate derivative. Suitable plasticizers are, among others, C₂₋₄ alcohols, which comprise 1-5 hydroxyl groups, or esters of these, alkyl esters of citric acid or a mixture of two or more materials also in the form of aqueous solutions.

More preferably, a biodegradable plasticizer is used.

Examples of suitable plasticizers are: mono-, di- and triglyceric ester of acetic acid, propylene glycol, dipropylene glycol, glycerol, mono-, di- or trialkyl esters of citric acid, particularly mono-, di- or tri-C₁₋₄-alkyl esters, or mixtures of several of these materials, and plain water and aqueous solutions of plasticizers.

According to a preferable embodiment of the present invention, the plasticizing material is glycerol monoacetate, which is a non-toxic, non-volatile (flash point>110° C.), water-soluble liquid which is preferably used within the temperature range+17.8 (melting point) and +290° C. (decomposition point).

The ratio of the quantity of plasticizer to the quantity of carbohydrate derivative varies widely. Generally, the quantity is approximately 1:100-500:100 (parts per weight/parts per weight), more preferably the quantity of plasticizer is at least approximately 30:100, especially at least approximately 50:100-500:100 (parts per weight/parts per weight).

An example of what is presented above is, thus, that the polymer, which is cellulose acetate or oxidized cellulose acetate or starch acetate or oxidized starch acetate or a natural or synthetic polymer with similar material properties, is plasticized by using processing methods that are generally known in plastic technology, in such a way that the percentage of the plasticizer is 20-200% or more preferably 60-150% or 80-120%.

It is also possible to add to the polymer an optically active additive by which the transmission of light (i.e. reflection and absorption of light) can be adjusted. Examples are materials which limit the transmission at one wavelength and increase the transmission at another. For instance, it is possible to use fluorescent materials or corresponding materials which absorb radiation within the UV range and emit that radiation within the wavelength range of visible light. The percentages of such materials are generally (calculated from the polymer) approximately 0.01-20 weight-%, especially approximately 0.1-10 weight-%.

The fibrous product to be treated is essentially a planar product, such as a paper or cardboard sheet or a paper or a cardboard web. The fibrous product to be treated can also be a package or similar product which is prepared from paper or cardboard by a process of conversion.

The quantity of the plasticized carbohydrate derivative, which is applied locally onto the surface of the fibrous product, is approximately 1-500 g/m², especially approximately 10-350 g/m², most suitably approximately 50-250 g/m².

The grammage of the fibrous product to be treated is approximately 40-500 g/m², especially approximately 80-350 g/m². The fibrous product can comprise a chemical cellulose mass, mechanical mass or chemi-mechanical mass or a combination of two or more masses.

The quantities of the carbohydrate derivative to be applied and of the plasticizer included in it are selected according to the grammage and the porosity of the fibrous product in such a way that the quantities of the carbohydrate derivative to be applied along with its plasticizer are, in relation to the material quantity of the fibrous product at the point of application, approximately 10:100 . . . 250:100 (parts per weight/parts per weight), in which case the weight ratio between the carbohydrate derivative and the plasticizing agent is approximately 1:10 . . . 10:1.

The plasticized carbohydrate derivative can be applied to and integrated into one side of the fibrous product, but according to a preferred embodiment, the plasticized carbohydrate derivative is applied to and integrated into both sides of the fibrous product.

The plasticized carbohydrate derivative is applied at a temperature of approximately 50-200° C. or it is heated in the fibrous product to this temperature.

The pressure/application pressure which is directed at the treatment point is generally approximately 0.1-20 MPa, especially approximately 0.5-10 MPa.

As described above, according to a preferred embodiment, the plasticizer is separately applied onto a fibrous product which is filled with carbohydrate derivative. Thus, in this embodiment, it is possible to apply the plasticizer onto the fibrous product by using a stencil, thereby limiting the area. This enables the formation of precisely defined transparent areas.

It is possible to use any suitable technique for the application of a plasticized carbohydrate derivative. In particular, pressing, extrusion, flexo printing, screen printing, transfer film techniques or other such techniques are used, among which especially screen printing, i.e. serigraphy technique, is a most interesting option.

Film which is prepared of plasticized polymer by using the transfer film technique is placed at a desired point on both sides of the cardboard and pressed in order to attach it to the cardboard. The surfaces of the press must be anti-adhesive. A window of a desired design is easy to obtain in the fibrous product.

Polymer which is plasticized by using an extrusion technique is applied in a liquid state at a desired point on the cardboard, after which the cardboard is immediately driven between press/calender rolls, in which case the impregnation of the polymer into the cardboard takes place.

In the flexo printing method, liquid polymer is used instead of printing ink. This technique can be used for instance when the polymer has been added in powder form to the cardboard, and thereafter only the plasticizer is added.

The present invention can be used to produce foodstuff packages, consumer packages, transport packages, and watermarked paper and similar products which include figures formed of transparent areas.

According to one preferred embodiment, the transparent area is generated at a desired point on the fibrous product, for instance in such a way that it forms only part of the surface of the final fibrous product.

The following illustrating examples do not restrict the scope of protection of the present invention.

### EXAMPLE 1

### Oxidizing of Starch Acetate by Using Hydrogen Peroxide

50 kg of amylose-rich starch triacetate (DS≧2.6 acetyl) were loaded into a 250 L DRAISS reactor, after which 33.3 kg of 15% hydrogen peroxide were mixed into the starch acetate. Heat and a vacuum suction were connected to the reactor in order to remove the excess water together with the oxygen which was released by the reaction. After the temperature had risen to 60 degrees, the product expanded over a period of one hour to approximately double its volume and became clearly plasticized by the remaining moisture, its state now being a flexible foam. As a result of the effect of water, the starch ester was plasticized to the desired state, and consequently, the reaction was interrupted by shutting off the heat. The cooled and hardened starch foam was crushed with the help of the mixers of the reactor, and dried, first at room temperature, and then at a temperature of 60° C. in a ventilated oven.

The molecular weight of the product 250 MOX was determined by using GPC.

Number-average molecular weight: Mₙ=21,671
Weight-average molecular weight: M_{w}=822,766

The product is completely soluble in most technical solvents, such as acetone, ethyl acetate and their mixtures with these and alcohol, and also in mixtures of acetone, alcohol and water.

### Viscosity

250 MOX 15% ethyl acetate:ethanol (1:1) 27.2 cP
250 MOX 15% ethyl acetate: 20.9 cP

### EXAMPLE 2

### Oxidizing of Starch by Means of an Extrusion Process

Oxidizing of an amylose-rich starch ester according to example 1 was carried out using an extruder. This extruder was a Brabender Plasti-Corder PL 2100-6 1 screw extruder for laboratory purposes, the screw geometry of which was chosen to ensure efficient forward transportation of material. The orifice used was a plate orifice.

The hydrogen peroxide was dosed by spraying it into the starch triacetate in a fluidized bed-type mixer, according to the following formula:

1000 g of starch triacetate
333 g of 15% aqueous solution of hydrogen peroxide

The product, prepared according to the formula and method above, was fed into the extruder from which it came out as fairly soft, plate-like and substantially foamed. The temperature profile of the extruder was 90-150° C. After drying, the product was hardened and was very brittle.

### EXAMPLE 3

### Oxidizing of Cellulose Acetate by Using Hydrogen Peroxide

Powdery cellulose acetate was weighed into a mixer of fluidized bed-type, which in this case was called the “dough machine” Electrolux Assistant. 35% of an aqueous solution of hydrogen peroxide was dosed with a spraying bottle into the powder with simultaneous mixing. After the dosing, the powder was moved to another vessel, which was placed into a ventilated oven. The purpose of the oven was to accelerate the reaction of the hydrogen peroxide. Because of the spontaneous combustion of the peroxide when the concentration is >16%, the laboratory tests were carried out in three stages, each with a 5% dosing. A sample was taken in each stage and the MFR (Melt Flow Rate) was analyzed from each sample and a melt was prepared, the viscosity of which was measured.

### Material Quantities:

| | |
|---|---|
| Experiment I, 5% H₂O₂ | |
| Cellulose acetate (CA) | 100 grams (calculated as |
| | dry matter) |
| Aqueous solution of peroxide (35%) | 14.3 grams (5% of the CA |
| | quantity) |
| Experiment II, 10% H₂O₂ | |
| Cellulose acetate of experiment I | 100 grams (calculated as |
| | dry matter) |
| Aqueous solution of peroxide (35%) | 14.3 grams (5% of the CA |
| | quantity) |
| Experiment III, 15% H₂O₂ | |
| Cellulose acetate of experiment II | 100 grams (calculated as |
| | dry matter) |
| Aqueous solution of peroxide (35%) | 14.3 grams (5% of the CA |
| | quantity) |

The reaction of the hydrogen peroxide was accelerated in an oven for a period of 3-5 h at a temperature of 110° C. after each dosing. It can be assumed that during this time the hydrogen peroxide reacts totally and is converted into water and oxygen.

### Analyses

Melt Flow Rate indexes were prepared for the oxidized cellulose acetates (CAox:s). Temperature 230° C., preheating during 180 s, mass 2.16 kg

| Sample | Manual | Auto |
|---|---|---|
| 5% | 1.64 g/10 min | 1.51 cm³/10 min |
| 10% | 2.16 g/10 min | 2.05 cm³/10 min |
| 15% | 11.8 g/10 min | 8.32 cm³/10 min |

The melt viscosity (Brookfield-Thermocell) of the products from the experiments I-III was measured after they were plasticized with triethyl citrate, the proportion being 1:1.

| Sample | Viscosity, 200° C., shear rate 0.28 1/s |
|---|---|
| 5% | 24 900 cP |
| 10% | 24 500 cP |
| 15% | 12 200 cP |

The results show that, at hydrogen peroxide levels of 5% and 10%, the viscosity levels are almost identical, but increasing the hydrogen peroxide level from 10% to 15% lowers the viscosity to less than half.

### EXAMPLE 4

### Production of Plasticized Cellulose Acetate

The plasticized cellulose acetate according to this example was produced by using a Berstorff twin-screw compounder. First, a mixture comprising cellulose acetate (67 weight-%) and 50 php (per hundred polymer) of TEC (33 weight-%) was prepared from cellulose acetate and triethyl citrate (TEC). The state of the mixture was a dryish powder. The powder was fed by way of a gravimetric feeder into the compounder. The product generated from the compounder was strip-like and it was granulated by using a strip cutter. The temperature profile was 190-240° C.

The materials with a higher percentage of plasticizer were prepared by means of a Brabender batch mixer from the granules generated from the twin-screw compounder and TEC in such a way that the percentages of plasticizer were 100 php and 150 php. The temperature of the batch mixer was 200° C.

### EXAMPLE 5

### Impregnation of Plasticized Cellulose Acetate into Paper or Cardboard, by Using a Hot Plate Press

In the method according to this example, a small piece of cellulose acetate, which is plasticized according to example 4, and a cardboard sheet were placed between anti-adhesive plastic films, which in this case were polyethylene tereftalate, and introduced between the plates of the hot plate press. The temperature of the plates of the hot plate press was 180° C. and the pressing was carried out in such a way that the moving plate was first brought into contact with the samples and then the plasticized cellulose acetate was allowed to get warm. When the plasticized cellulose acetate had clearly begun to melt, the press was pressed together and the pressure was increased to 100-120 bar. The sample was compressed for 15 seconds, after which the press was opened and the sample was taken out and allowed to cool. After the sample had cooled, the plastic films were removed. The result was a round transparent area which was very transparent in the middle but with degree of transparency decreasing towards the edges. The side of the cardboard on which the cellulose acetate was applied was very shiny, whereas the other side was opaque. The method was also applied in such a way that pieces of plasticized cellulose acetate were placed on both sides of the cardboard sheet, followed by hot pressing. In this case, both surfaces were shiny, and the transparency also improved.

### EXAMPLE 6

### Production of Plasticized Cellulose Acetate Film

A film according to this example was prepared by using hot plate pressing in such a way that a suitable amount of plasticized cellulose acetate was dosed between siliconized paper sheets and thickness gauges were placed on the edges of the paper, the thicknesses of which gauges were varied according to the desired thickness of the film (5-30 μm). The temperature of the press was 180° C. and the pressure varying in the range 40-200 bars, depending on the desired thickness of the film. A high pressure was used when thin films were prepared. The plasticized cellulose acetate was first allowed to warm, after which the pressure was increased, and maintained for approximately 15 seconds, and then the press was opened and the sample was taken out and allowed to cool. After the film had cooled, the siliconized papers were removed and the round film was cut to size 12.5 cm*12.5 cm. The film generated was weighed and used for the impregnation of the cardboard.

### EXAMPLE 7

### Impregnation of Cardboard or Paper by Using Films which are Made of Plasticized Cellulose Acetate

The impregnation according to the method of this example was carried out by using a hot plate press exactly in the same way as in example 5, but instead of plasticized cellulose acetate pieces, a film which was prepared according to example 6 was used. As a result, the final product was substantially smoother.

TABLE 1

| | | | Weight of | |
|---|---|---|---|---|
| | | | impregnated | Densitometer |
| | Grammage | Impregnated | film/films | reading, black |
| Paper/cardboard | g/m² | material | grams | background |
| Pure cellulose | 40 | | | 0.02 |
| Pure cellulose | 40 | CA + 100 php | 80 | 0.8 |
| | | TEC | | |
| Pure cellulose | 40 | CA + 100 php | 65 | 0.79 |
| | | TEC | | |
| Pure cellulose | 100 | | | 0.01 |
| Pure cellulose | 100 | CA + 100 php | 65 + 65 | 0.76 |
| | | TEC | | |
| Pure cellulose | 100 | CA + 100 php | 65 + 50 | 0.79 |
| | | TEC | | |
| Pure cellulose | 200 | | | 0 |
| Pure cellulose | 200 | CA + 100 php | 200 | 0.55 |
| | | TEC | | |
| Pure cellulose | 200 | CA + 100 php | 140 + 60 | 0.57 |
| | | TEC | | |
| Pure cellulose | 300 | | | 0.01 |
| Pure cellulose | 300 | CA + 100 php | 220 | 0.2 |
| | | TEC | | |
| Pure cellulose | 300 | CA + 100 php | 190 + 110 | 0.5 |
| | | TEC | | |

The densitometer measurements are carried out against a black background. The value zero (0) indicates complete non-transparency. The value of 1 indicates complete transparency.

Other materials, too, were prepared, according to examples 4 and 6, to be films and pressed onto paper/cardboard sheets. These samples were not measured by a densitometer, instead the transparency was estimated visually.

TABLE 2

| | | | Weight of | |
|---|---|---|---|---|
| | | | impregnated | Estimated |
| | Grammage | Impregnated | film/films | transparency |
| Paper/cardboard | g/m² | material | grams | on scale 1-10 |
| Pure cellulose | 60 | Polylactide | 60 | 8 |
| Pure cellulose | 40 | CAB + | 50 | 9, clear |
| | | 100 php TEC | | interface |
| Pure cellulose | 60 | CAB + | 65 | 9, clear |
| | | 100 php TEC | | interface |
| Pure cellulose | 100 | Starch | 105 | 7, slightly |
| | | triacetate + | | opaque, |
| | | 50 php TEC | | surface |
| | | | | not shiny |
| Pure cellulose | 100 | Starch | 110 | 7 |
| | | triacetate + | | |
| | | 100 php TEC | | |

### EXAMPLE 8

### Production of an Aqueous Slurry/Dispersion from Material 250 MOX According to example 1

The purpose of this experiment is to use a filler process to produce a filler for paper/cardboard, which filler melts when heated.

### Starting Situation

| | | |
|---|---|---|
| 6 | g | of oxidized starch acetate 250 MOX-1-06 |
| 200 | ml | at a ratio of 1:1 acetone/ethanol mixture, into which |
| | | the polymer is dissolved |
| 50 | ml | of water, which is added after the polymer is |
| | | dissolved into the acetone/ethanol mixture |

The solution prepared above is fed via a pipette in doses of approximately 5 ml into 1600 ml of water (the feeding takes approximately 5 minutes); at the same time the aqueous solution is briskly mixed with a magnet; the mixing is continued with a magnet for 2 h, during which time the quantity of the acetone in the solution decreases essentially by evaporation.

The result is a fine dispersion of oxidized starch acetate 250 MOX, which does not settle or settles very slowly.

### EXAMPLE 9

### Sheet which is Plasticized by Using Gradient Calendering

In the experiments, the addition of thermoplastic starch 250 MOX to a 60 g/m² paper sheet, which was produced by using a sheet mould, was tested. Different quantities of the added thermoplastic starch were used. The sheet was produced by adding a required quantity of fibre slush and bleached softwood pulp into the sheet mould in order to produce a sheet having a grammage of 60 g/m² and a size of 165×165 mm. After the addition of the fibre slush, a desired quantity of thermoplastic starch 250 MOX was added into the sheet mould. In order to maintain the grammage of the sheet at the desired 60 g/m², the quantity of the fibre slush was reduced as required. After the addition of the 250 MOX, the sheet was drained on the wire, 3 blotting boards were placed on top of it, the sheet was rolled 5 times back and forth by means of a 5 kg rolling pin, after which it was detached from the wire and the topmost 2 blotting boards were removed.

The 250 MOX was retained on the sheet chemically and/or mechanically. After the drainage, the wire side of the sheet was placed onto the dryer plate and the sheets were compressed with a laboratory press at a compression load of 3.5 kPa for a period of 5+2 minutes.

After the compression, the sheets were dried in the laboratory at a relative humidity of 50% and at a temperature of 23° C., for a period of at least 24 hours in order to prevent them from shrinking. The dry sheets were detached from the drying plates.

After the drying, the sheets were placed in a humidity cabinet at a relative humidity of 90%, in order to increase the level of the moisture absorbed into the 250 MOX-filled sheets, and to plasticise the 250 MOX. The sheets were exposed to a relative humidity of 90% for at least 4 hours. After that, the sheets were enclosed individually in Minigrip bags to wait for calendering.

The sheets were individually removed from the Minigrip bags immediately before the calendering. The purpose of the calendering was to use moisture and heat to render the termoplastic starch translucent. The calendering of the sheets was carried out between two heated metal cylinders. The surface temperature of the metal cylinders was raised to at least 40° C. above the plasticizing temperature of the 250 MOX, in order to allow the thermoplastic starch to plasticise during the short nip contact (i.e. while it is between the two metal cylinders).

After the calendering, transparent/translucent places could be seen in the sheets, in which places thermoplastic starch had accumulated in somewhat larger quantities, partly because of poor dispersing. The thermoplastic starch had melted, which could be verified with a microscope.

### EXAMPLE 10

### Local Plasticizing of Thermoplastic Starch

In the experiments, the addition of thermoplastic starch 250 MOX to a 60 g/m² paper sheet, which was produced by using a sheet mould, was tested. The quantity of thermoplastic starch added during the experiments was 10%. The sheet was produced by adding a required quantity of fibre slush and bleached softwood pulp into the sheet mould in order to produce a sheet having a grammage of 60 g/m² and a size of 165×165 mm. After the addition of the fibre slush, 10% of thermoplastic starch 250 MOX was added into the sheet mould. The grammage of the final sheet was 72 g/m². After the addition of the 250 MOX, the sheet was drained on the wire, 3 blotting boards were placed on top of it, the sheet was rolled 5 times back and forth by means of a 5 kg rolling pin, after which it was detached from the wire and the topmost 2 blotting boards were removed.

The 250 MOX was retained on the sheet chemically and/or mechanically. After the drainage, the wire side of the sheet was placed onto the dryer plate and the sheets were compressed with a laboratory press at a compression load of 3.5 kPa for a period of 5+2 minutes.

After the compression, the sheets were dried in the laboratory at a relative humidity of 50% and at a temperature of 23° C., for a period of at least 24 hours in order to prevent them from shrinking. The dry sheets were detached from the drying plates.

The thermoplastic starch 250 MOX in the sheets was locally melted with the help of a stencil, in which case a transparent figure was formed in the sheet. Monoacetin, a melting additive, was sprayed onto the sheet. The spraying was carried out as follows:

The 72 g/m² paper was placed on the top of a vacuum table, a stencil pre-cut from an overhead film was placed on the paper, the vacuum suction was connected and monoacetin was sprayed. Excess monoacetin was mechanically absorbed away immediately after the spraying. The quantity of the monoacetin to be sprayed was difficult to determine because it was added by a hand sprayer.

The result obtained is shown in the accompanying FIGURE.

1. A method of generating transparent areas in a fibrous product, characterized in that
a carbohydrate derivative including a plasticizer is incorporated into the fibrous product, and
the carbohydrate derivative which is plasticized with a plasticizer is brought, in a liquid state and under pressure, to migrate in between the fibres of the product in such a way that at least part of the plasticizer penetrates into the lumens of the fibres.

2. The method according to claim 1, characterized in that the plasticized carbohydrate derivative is heated to or above its melting point, in order to melt the carbohydrate derivative.

3. The method according to claim 1 or 2, characterized in that the plasticized carbohydrate derivative is applied in a liquid state or as a dispersion onto the surface of the fibrous product, in which case it is brought, under pressure and possibly heat, to penetrate in between the fibres.

4. The method according to claim 1 or 2, characterized in that the carbohydrate derivative is used as a filler in the fibrous product, and that a plasticizer is applied onto the fibrous product which comprises a carbohydrate derivative, by using pressure and possibly heat, in order to plasticise the carbohydrate derivative and to bring it to penetrate in between the fibres.

5. A method according to claim 1, characterized in that the carbohydrate derivative is a derivative of cellulose, starch or dextrin or a mixture of two or more derivatives.

6. The method according to claim 5, characterized in that the carbohydrate derivative is a cellulose C₁₋₄ alkyl ester, an oxidized cellulose C₁₋₄ alkyl ester, a starch C₁₋₄ alkyl ester, an oxidized starch C₁₋₄ lower alkyl ester, or a mixture thereof.

7. A method according to claim 5, characterized in that the glass transition temperature of the plasticized carbohydrate derivative is at maximum 210° C., especially at maximum 170° C., most suitably at maximum 150° C.

8. A method according to claim 1, characterized in that a monomeric plasticizer is used.

9. A method according to claim 1, characterized in that the plasticizer is a C₂₋₄ alcohol, which comprises 1-5 hydroxyl groups or an ester of it, an alkyl ester of citric acid or a mixture of two or more materials, or an aqueous mixture or aqueous dispersion of these, or plain water.

10. The method according to claim 9, characterized in that the plasticizer is a glycerol ester, propylene glycol, dipropylene glycol, glycerol of acetic acid, or mono-, di- or trialkyl ester, particularly mono-, di- or tri-C₁₋₄-alkyl ester of citric acid, or a mixture of several of these materials.

11. A method according to claim 8, characterized in that the plasticizer is biodegradable.

12. A method according to claim 1, characterized in that the ratio of the quantity of the plasticizer to the quantity of the carbohydrate derivative ranges approximately 1:100-500:100 (parts per weight/parts per weight).

13. A method according to claim 1, characterized in that the fibrous product to be treated is essentially a planar product, such as a paper or a cardboard sheet or a paper or a cardboard web.

14. A method according to claim 1, characterized in that the quantity of the plasticized carbohydrate derivative which is to be locally applied onto the surface of the fibrous product or which is locally present in the fibrous product is approximately 1-500 g/m², especially approximately 10-350 g/m², most suitably approximately 50-250 g/m².

15. A method according to claim 1, characterized in that the grammage of the fibrous product to be treated is approximately 40-500 g/m², especially approximately 80-350 g/m².

16. The method according to claim 14, characterized in that the quantities of the carbohydrate derivative and the plasticizer contained in it are chosen according to the grammage of the fibrous product in such a way that the application quantities of the carbohydrate derivative and the plasticizer in relation to the material quantity of the fibrous product at the point of treatment is approximately 10:100 . . . 250:100 (parts per weight/parts per weight), in which case the weight ratio between the carbohydrate derivative and the plasticizer is approximately 1:10 . . . 10:1.

17. A method according to claim 1, characterized in that there is plasticized carbohydrate derivative on both sides of the fibrous product, or in that the derivative is applied on both sides of the fibrous product.

18. A method according to claim 1, characterized in that the plasticized carbohydrate derivative is applied at a temperature of approximately 50-200° C.

19. A method according to claim 1, characterized in that a pressure of approximately 0.1-20 MPa, especially approximately 0.5-10 MPa is directed at the plasticized carbohydrate derivative.

20. A method according to claim 4, characterized in that plasticizer is applied with the help of a stencil onto the fibrous product, in order to limit the area to be treated.

21. A method according to claim 1, characterized in that pressing, extrusion, flexo printing, a transfer film technique or similar technique is used to apply the carbohydrate derivative or the plasticizer.

22. A method according to claim 1, characterized in that a foodstuff package, a consumer package or a watermarked paper having figures formed by transparent areas is produced.

23. A method according to claim 1, characterized in that the transparent area is generated at a desired place on the fibrous product, for instance in such a way that it forms only part of the surface of the final fibrous product.

24. A method according to claim 1, characterized in that at least approximately 10 weight-%, preferably approximately 25 weight-% of the plasticizer is separated from the carbohydrate derivative during the application.

25. A method according to claim 1, characterized in that at least approximately 5 weight-%, most suitably approximately 10-90 weight-% of the plasticizer which is used for the plasticizing of the carbohydrate derivative is brought to penetrate into the lumens of the fibres of the fibrous product.

26. A fibrous product which has at least one transparent area, characterized in that the transparent area comprises a carbohydrate derivative which is plasticized with a plasticizer and that the lumen of the fibres of the transparent area comprises at least some plasticizer.

27. The fibrous product according to claim 26, characterized in that the product is a paper or cardboard sheet, or a paper or cardboard web or a product made of these by conversion, such as a package.

28. A fibrous product according to claim 26 or 27, characterized in that the transparent area forms at maximum approximately 50%, especially at maximum approximately 25%, most suitably at maximum approximately 15%, especially approximately 10-1% of the area of the fibrous product.

29. A fibrous product according to claim 26, characterized in that it is produced by using a method according to claim 1.
